(19) United States
(12) Patent Application Publication
(10) Pub. No.: US 2011/0117341 A1
(43) Pub. Date: May 19, 2011

(54) MULTILAYERED FILM WITH EXCELLENT ANTIFOGGING PROPERTY

(75) Inventors: Hiroyuki Yoshizaki, Shiga (JP); Norio Uehara, Shiga (JP); Naoyuki Maruichi, Shiga (JP); Takehiko Toyonaga, Shiga (JP)

(73) Assignee: GUNZE LIMITED, Ayabe-shi, Kyoto (JP)

(21) Appl. No.: 12/996,513

(22) PCT Filed: Jun. 3, 2009
(86) PCT No.: PCT/JP2009/060192

§ 371 Date: Dec. 6, 2010

(30) Foreign Application Priority Data
Jun. 6, 2008 (JP) 2008-148822

(51) Int. Cl. B32B 27/08; B32B 5/00; B32B 7/02; B29C 47/06

(52) U.S. Cl. 428/213; 428/476.3; 428/220; 428/332; 264/173.14

(57) ABSTRACT

The present invention provides a film that has excellent anti-fogging properties, processability without causing curling, as a film for use in food packaging. Specifically, the present invention provides a multilayered film including a polyolefin layer (A), an adhesive layer (B), a polyamide layer (C), a barrier layer (D), an anti-fogging agent layer (E), and an anti-fogging agent volatilization-preventing layer (F), the polyamide layer (C) including 5 to 30 wt % of amorphous aromatic polyamide, the barrier layer (D) including a saponified ethylene vinyl acetate copolymer (EVOH) having an ethylene content of 35 mol % or less and a saponification degree of vinyl acetate of 90 mol % or more, the anti-fogging agent layer (E) including an anti-fogging agent and polyolefin, and the anti-fogging agent volatilization-preventing layer (F) including polyolefin; and the multilayered film having an (A)/(B)/(X)/(B)/(E)/(F) layer structure (wherein the layer (X) represents a (C)/(D)/(C), (D)/(C)/(D), (C)/(D), or (D)/(C) layer structure); and a method for producing the same.

### TECHNICAL FIELD

The present invention relates to a multilayered film with excellent anti-fogging properties and excellent processability.

### BACKGROUND ART

In regard to films used for packaging fresh vegetables, livestock meat such as raw meat and minced meat, etc., moisture from such products generally attaches to the films during refrigerated storage at store counters, causing fogging and thereby resulting in a bad appearance.

Patent Document 1 discloses a method for laminating on the outer side of an anti-fogging agent layer a layer for preventing volatilization of the anti-fogging agent. In this case, however, the processability is insufficient because the film curls.

Further, for the preservation of products, a saponified ethylene-vinyl acetate copolymer (EVOH) is used for providing barrier properties with the films; however, since EVOH with a high ethylene content is used to provide stretchability, gas barrier properties are insufficient, resulting in poor storage stability.

### PRIOR ART REFERENCE

### Patent Documents

Patent Document 1: Japanese Unexamined Patent Publication No. 2003-39606

### SUMMARY OF INVENTION

### Problems to be Solved by the Invention

An object of the present invention is to provide a film for food packaging that has excellent anti-fogging properties, processability without causing curling, barrier properties, and stretchability.

### Means for Solving the Problems

The present inventors conducted extensive research to achieve the above object. As a result, they found that the object can be attained by a multilayered film that contains a polyolefin layer (A), an adhesive layer (B), a polyamide layer (C), a barrier layer (D), an anti-fogging agent layer (E), and an anti-fogging agent volatilization-preventing layer (F), wherein the polyamide layer (C) contains 5 to 30 wt % of amorphous aromatic polyamide, the barrier layer (D) contains a saponified ethylene vinyl acetate copolymer (EVOH) having an ethylene content of 35 mol % or less, and a saponification degree of vinyl acetate of 90 mol % or more, the anti-fogging agent layer (E) contains an anti-fogging agent and polyolefin, and the anti-fogging agent volatilization-preventing layer (F) contains polyolefin; and the multilayered film has an (A)/(B)/(X)/(B)/(E)/(F) layer structure (herein (X) represents a (C)/(D)/(C), (D)/(C)/(D), (C)/(D), or (D)/(C) layer structure).

Based on the above findings, the inventors conducted further research, and accomplished the present invention.

Specifically, the present invention provides the following multilayered film and production process thereof.

Item 1. A multilayered film comprising a polyolefin layer (A), an adhesive layer (B), a polyamide layer (C), a barrier layer (D), an anti-fogging agent layer (E), and an anti-fogging agent volatilization-preventing layer (F),

the polyamide layer (C) comprising 5 to 30 wt % of amorphous aromatic polyamide,

the barrier layer (D) comprising a saponified ethylene vinyl acetate copolymer (EVOH) having an ethylene content of 35 mol % or less and a saponification degree of vinyl acetate of 90 mol % or more,

the anti-fogging agent layer (E) comprising an anti-fogging agent and polyolefin, and

the anti-fogging agent volatilization-preventing layer (F) comprising polyolefin; and

the multilayered film having an (A)/(B)/(X)/(B)/(E)/(F) layer structure (wherein the layer (X) represents a (C)/(D)/(C), (D)/(C)/(D), (C)/(D), or (D)/(C) layer structure).

Item 2. The multilayered film according to Item 1, wherein each of the polyolefins contained in the polyolefin layer (A), the anti-fogging agent layer (E), and the anti-fogging agent volatilization-preventing layer (F) is linear low-density polyethylene (LLDPE) and/or low-density polyethylene (LDPE).

Item 3. The multilayered film according to Items 1 or 2, wherein the amorphous aromatic polyamide contained in the polyamide layer (C) is at least one member selected from the group consisting of polymers of hexamethylenediamine/isophthalic acid, polymers of hexamethylenediamine/terephthalic acid, and copolymers of hexamethylenediamine/terephthalic acid/hexamethylenediamine/isophthalic acid.

Item 4. The multilayered film according to any one of Items 1 to 3, wherein the content of the anti-fogging agent in the anti-fogging agent layer (E) is 15,000 to 40,000 ppm.

Item 5. The multilayered film according to any one of Items 1 to 4, wherein the multilayered film is biaxially stretched 2 to 4.5 times its original size in a machine direction, and 2.5 to 5 times its original size in a transverse direction.

Item 6. The multilayered film according to any one of Items 1 to 5, wherein the multilayered film has a total thickness of 10 to 50 μm.

Item 7. The multilayered film according to any one of Items 1 to 6, wherein the thickness of the anti-fogging agent volatilization-preventing layer (F) is 0.5 to 3 μm.

Item 8. The multilayered film according to any one of Items 1 to 7, wherein the total thickness of the polyamide layer (C) is 20 to 60% of the total thickness of the multilayered film.

Item 9. The multilayered film according to any one of Items 1 to 8, wherein the thickness of the layer (X) is 3 to 40 μm.

Item 10. The multilayered film according to any one of Items 1 to 9, wherein the ratio ((C)/(D)) of the total thickness of the polyamide layer(s) (C) to the total thickness of the barrier layer(s) (D) in the layer (X) is 1/2 to 30/1.

Item 11. The multilayered film according to any one of Items 1 to 10, wherein the multilayered film has at least an eight-layer (A)/(B)/(C)/(D)/(C)/(B)/(E)/(F) structure.

Item 12. The multilayered film according to any one of Items 1 to 11, wherein the multilayered film is a heat-shrinkable film.

Item 13. A method for producing a multilayered film comprising:

laminating a resin for a polyolefin layer (A), a resin for an adhesive layer (B), a resin for a polyamide layer (C) comprising 5 to 30 wt % of amorphous aromatic polyamide, a resin for a barrier layer (D) comprising a saponified ethylene vinyl acetate copolymer (EVOH) having an ethylene content of 35 mol % or less, and a saponification degree of vinyl acetate of 90 mol % or more, a resin for an anti-fogging agent layer (E) comprising an anti-fogging agent and polyolefin, and a resin for an anti-fogging agent volatilization-preventing layer (F) comprising polyolefin, by co-extrusion so that the film has a layer structure in (A)/(B)/(X)/(B)/(E)/(F) order (wherein the layer (X) represents a (C)/(D)/(C), (D)/(C)/(D), (C)/(D), or (D)/(C) structure).

### Effects of the Invention

The multilayered film of the present invention has, as a film for use in food packaging, good anti-fogging properties, and processability without causing curing. Further, by using EVOH having a low ethylene content in the barrier layer (D), and a specific amount of amorphous aromatic polyamide in the polyamide layer (C), the multilayered film also offers good gas barrier properties and excellent stretchability.

### MODE FOR CARRYING OUT THE INVENTION

The present invention will be described in detail below.

### I Multilayered Film

The multilayered film of the present invention is a multilayered film that comprises a polyolefin layer (A), an adhesive layer (B), a polyamide layer (C), a barrier layer (D), an anti-fogging agent layer (E), and an anti-fogging agent volatilization-preventing layer (F), wherein the polyamide layer (C) contains 5 to 30 wt % of amorphous aromatic polyamide, the barrier layer (D) contains a saponified ethylene vinyl acetate copolymer (EVOH) having an ethylene content of 35 mol % or less, and a saponification degree of vinyl acetate of 90 mol % or more, the anti-fogging agent layer (E) contains an anti-fogging agent and polyolefin, and the anti-fogging agent volatilization-preventing layer (F) contains polyolefin. Further, the multilayered film has an (A)/(B)/(X)/(B)/(E)/(F) layer structure (wherein the layer (X) represents a (C)/(D)/(C), (D)/(C)/(D), (C)/(D), or (D)/(C) layer structure).

Because the multilayered film comprises an anti-fogging agent layer (E), and an anti-fogging agent volatilization-preventing layer (F) on the outer side of the anti-fogging agent layer (E), good anti-fogging properties can be attained, and volatilization of the anti-fogging agent during production can be inhibited.

Further, since the layer (A) containing polyolefin, and the layers (E) and (F) each containing polyolefin are located on the sides of the inner layer (X), the multilayered film is free of curling, and has excellent processability.

Furthermore, by enhancing the barrier properties of the multilayered film by setting the ethylene content of a saponified ethylene vinyl acetate copolymer contained in the barrier layer (D) to 35 mol % or less, and by incorporating 5 to 30 wt % of amorphous aromatic polyamide into the polyamide layer (C), good stretchability of the multilayered film can be attained.

### Polyolefin Layer (A)

The polyolefin layer (A) contains polyolefin. Examples of polyolefin include homopolymers of olefins, mutual copolymers of olefins, and copolymers of olefins with other copolymerizable monomers (for example, other vinyl monomers). More specifically, examples thereof include polyethylene, polypropylene, polybutene, mutual copolymers thereof, ionomer resins, ethylene-acrylic acid copolymers, ethylene-vinyl acetate copolymers, etc. Linear low-density polyethylene (LLDPE), low-density polyethylene (LDPE), etc. are preferred, and LLDPE and/or LDPE are more preferred.

### Adhesive Layer (B)

The adhesive layer (B) contains modified polyolefin as an adhesive resin. This ensures strong adhesion between the polyolefin layer and the polyamide layer, and improves the peel strength of both layers after adhesion.

Examples of modified polyolefin include modified polymers obtained by copolymerizing (for example, graft copolymerization) polyolefin with unsaturated carboxylic acids or derivatives of unsaturated carboxylic acids. Examples of polyolefin include homopolymers of olefins, mutual copolymers of olefins, and copolymers of olefins with other copolymerizable monomers (for example, other vinyl monomers). Specific examples thereof include polyethylene (LDPE, LLDPE, etc.), polypropylene, polybutene, mutual copolymers thereof, ionomer resins, ethylene-acrylic acid copolymers, ethylene-vinyl acetate copolymers, etc. Examples of unsaturated carboxylic acids or derivatives thereof include maleic acid, fumaric acid, and like unsaturated carboxylic acids, acid anhydrides of unsaturated carboxylic acids, esters of unsaturated carboxylic acids, metal salts of unsaturated carboxylic acids, etc. Of these, maleic acid modified polyolefin is preferably used as modified polyolefin.

Specific examples thereof include maleic anhydride modified polyolefin resin (e.g., ADMER NF518, ADMER SF730, ADMER SF731, ADMER SF740, and ADMER SE800; produced by Mitsui Chemicals, Inc.) etc.

### Polyamide Layer (C)

The polyamide layer (C) comprises amorphous aromatic polyamide (amorphous nylon) as an essential component. Examples of amorphous aromatic polyamide include those having, as a main backbone, a polymerized structure of hexamethylenediamine and terephthalic acid and/or isophthalic acid. Specific examples thereof include polymers of hexamethylenediamine/isophthalic acid, polymers of hexamethylenediamine/terephthalic acid, copolymers of hexamethylenediamine/terephthalic acid/hexamethylenediamine/isophthalic acid, etc.

Specific examples thereof include Selar PA 3426, produced by DuPont-Mitsui Polychemicals Co., Ltd.; Novamid X-21, produced by Mitsubishi Engineering-Plastics Corp.; etc.

The content of amorphous aromatic polyamide in the polyamide layer (C) is 5 to 30 wt %, preferably 5 to 25 wt %, and more preferably 5 to 20 wt %. At a content of less than 5 wt %, the stretchability of the resulting multilayered film is lowered, whereas at a content of more than 30 wt %, the strength of the film is reduced. In the multilayered film of the present invention, it is believed that the stretchability is lowered because the ethylene content (35 mol % or less) in EVOH that is contained in the barrier layer (D) is set low in order to provide high gas barrier properties. Therefore, by using the specific content of amorphous aromatic polyamide having high stretchability for the polyamide layer (C) adjacent to the barrier layer (D), good stretchability of the multilayered film is attained.

Examples of polyamide other than amorphous aromatic polyamide used in the polyamide layer (C) include poly-ε-capramide (nylon 6; Ny6), polyhexamethylene adipamide (Nylon 66; Ny66), poly undecamide (Nylon 11; Ny11), polylauramide (Nylon 12; Ny12), copolymers thereof, polymetaxylylene adipamide (MXDNy), and mixtures thereof. Preferable examples include Ny6, Ny6-66, and MXDNy.

### Barrier Layer (D)

The barrier layer (D) contains a saponified ethylene-vinyl acetate copolymer (EVOH). Gas barrier properties (particularly, oxygen gas barrier properties) are expected in a film for packaging. To fully maintain the gas barrier properties, it is advantageous that the content of ethylene in EVOH that is contained in the barrier layer be reduced. Therefore, the ethylene content of EVOH used in the present invention is not more than 35 mol %, preferably 26 to 32 mol %. A reduction in stretchability due to the low content of ethylene in EVOH is compensated by high stretchability of the polyamide layer (C), as described above. The saponification degree of a vinyl acetate component in EVOH is 90 mol % or more, preferably 95 mol % or more.

The melt index (MI) of EVOH is preferably 1 to 35 g/10 min (210° C., 2,160 g load), and more preferably 1 to 20 g/10 min (same as the above).

Preferable examples of EVOH include DC3203RB, DT2904RB (all manufactured by the Nippon Synthetic Chemical Industry Co., Ltd.), etc.

### Anti-Fogging Agent Layer (E)

The anti-fogging agent layer (E) contains polyolefin and an anti-fogging agent. Usable polyolefins are those mentioned in the section “Polyolefin layer (A)”. Preferably, linear low-density polyethylene (LLDPE), low-density polyethylene (LDPE), etc. are used, and more preferably LLDPE and/or LDPE are used.

Examples of anti-fogging agents include any of those having an anti-fogging effect. Typical examples thereof include fatty acid esters of polyalcohols, ethylene oxide adducts thereof, ethylene oxide adducts of high fatty acid amines, high fatty acid alkanol amides, etc. These compounds can be used alone, or, if needed, in a combination of two or more.

Although the content of the anti-fogging agent depends on the kinds of anti-fogging agent and resin in the anti-fogging agent layer, it is generally 15,000 to 40,000 ppm, and preferably 15,000 to 30,000 ppm in the anti-fogging agent layer.

The addition amount of other additives (anti-oxidants, heat stabilizers, lubricants, etc.) optionally used together with the anti-fogging agent is determined based on the structure, production conditions, and use of the film, the kinds of additives, etc. It is preferable that the total amount of additives (excluding the anti-fogging agent) in the anti-fogging agent layer be 10 wt % or less.

### Anti-Fogging Agent Volatilization-Preventing Layer (F)

The anti-fogging agent volatilization-preventing layer (F) contains polyolefin. Examples of polyolefin include those listed in the section “Polyolefin layer (A)”. It is preferable that linear low-density polyethylene (LLDPE), low-density polyethylene (LDPE), etc. be used, and it is more preferable that LLDPE and/or LDPE be used. By providing this layer, volatilization of the anti-fogging agent that is contained in the anti-fogging agent layer (E) can be prevented.

### Multilayered Film

The multilayered film of the present invention has an (A)/(B)/(X)/(B)/(E)/(F) layer structure (herein, the layer (X) represents a (C)/(D)/(C), (D)/(C)/(D), (C)/(D), or (D)/(C)) layer structure. Specifically, the multilayered film has an (A)/(B)/(C)/(D)/(C)/(B)/(E)/(F), (A)/(B)/(D)/(C)/(D)/(B)/(E)/(F), (A)/(B)/(C)/(D)/(B)/(E)/(F), or (A)/(B)/(D)/(C)/(B)/(E)/(F) layer structure.

Of the aforementioned multilayered films, the film (X) being (C)/(D)/(C), i.e., a multilayered film having an (A)/(B)/(C)/(D)/(C)/(B)/(E)/(F) layer structure, is preferred.

The multilayered film of the present invention usually has a total film thickness of 10 to 50 μm, preferably 15 to 35 μm, and more preferably 20 to 30 μm.

The barrier layer (D) usually has a total thickness of 1 to 10 μm, preferably 1 to 5 μm. Within the above range, the film has desired gas barrier properties. When the film contains two barrier layers (D), the sum of two layers' thickness is referred to as a total thickness.

The polyamide layer (C) usually has a total thickness of 2 to 30 μm, and preferably 3 to 20 μm. The total thickness of the polyamide layer (C) is 20 to 60%, and preferably 25 to 60% of the total thickness of the multilayered film. Within this range, a film can exhibit sufficient pinhole resistance properties, and stretchability. When the film includes two polyamide layers (C), the sum of two layers' thickness is referred to as a total thickness.

The thickness of the layer (X) is usually 3 to 40 μm, and preferably 4 to 25 μm. The ratio ((C)/(D)) of the total thickness of the polyamide layer(s) (C) to the total thickness of the barrier layer(s) (D) in the layer (X) is usually 1/2 to 30/1, and preferably 2 to 20/1. When the total thickness of the polyamide layer(s) (C) and the barrier layer(s) (D), and the ratio thereof are within the above range, a multilayered film exhibits higher gas barrier properties and stretchability.

The thickness of the anti-fogging agent layer (E) is usually 3 to 15 μm, preferably 4 to 12 μm. The thickness of the anti-fogging agent volatilization-preventing layer (F) is usually 0.5 to 3 μm, and preferably 1 to 2 μm. A thickness of 0.5 μm or more makes it easy to control the thickness during production, and a thickness of 3 μm or less ensures sufficient anti-fogging properties.

Polyolefin contained in the polyolefin layer (A), the anti-fogging agent layer (E), and the anti-fogging agent volatilization-preventing layer (F) may be the same or different, and adhesion resin in two adhesive layers (B) may be the same or different.

The multilayered film of the present invention has good anti-fogging properties, and can inhibit volatilization of the anti-fogging agent during production. Further, the multilayered film of the present invention is free of curling, and has excellent processability as well as gas barrier properties and stretchability. Furthermore, it has heat-shrinkable properties.

### II. Production of Multilayered Film

The multilayered film of the present invention can be produced by laminating a resin for a polyolefin layer (A), a resin for an adhesive layer (B), a resin for a polyamide layer (C) comprising 5 to 30 wt % of amorphous aromatic polyamide, a resin for a barrier layer (D) comprising a saponified ethylene vinyl acetate copolymer (EVOH) having an ethylene content of 35 mol % or less, and a saponification degree of vinyl acetate of 90 mol % or more, a resin for an anti-fogging agent layer (E) comprising an anti-fogging agent and polyolefin, and a resin for an anti-fogging agent volatilization-preventing layer (F) comprising polyolefin, by co-extrusion so that the film has a layer structure in (A)/(B)/(X)/(B)/(E)/(F) order (wherein the layer (X) represents a (C)/(D)/(C), (D)/(C)/(D), (C)/(D), or (D)/(C) layer structure).

Specifically, by coextruding a resin of each layer through a T die on a chill roll in which cooling water circulates, a flat multilayered film can be obtained. The temperature during extrusion is about 200 to 260° C.

The resulting multilayered film is subjected to biaxial stretching (simultaneous or sequential biaxial stretching). The film is stretched, for example, 2 to 4.5 times its original size in a machine direction (MD) and 2.5 to 5 times its original size in a transverse direction (TD). For example, in the case of sequential biaxial stretching, the film is stretched to 2 to 4.5 times its original size in the machine direction using a roll stretching machine set at 50 to 80° C. Then, the film is stretched to 2.5 to 5 times its original size in the transverse direction at an atmospheric temperature of 80 to 140° C. using a tenter stretching machine, and heat-treated at an atmospheric temperature of 100 to 140° C. using the tenter stretching machine. Thereby, the strength and heat shrinkable properties of the film are ensured.

If necessary, both sides or either side of the multilayered film of the present invention may be subjected to corona discharge treatment.

The multilayered film of the present invention can be preferably used as a film for packaging (particularly, a film for food packaging). The resulting package has good gas barrier properties and anti-fogging properties.

### EXAMPLES

The present invention will be described in more detail below by way of Comparative Examples and Examples; however, the present invention is not limited to these Examples.

The multilayered film produced was evaluated in the following manner.

Oxygen Permeability (unit: ml/m²·d·MPa)

The oxygen permeability was measured under the measuring conditions of 20° C.×65% RH according to JIS K 7126B. As a measuring device, an OX-TRAN Model 2/21 (produced by MOCON Inc.) was used.

A: Less than 30 ml/m²·d·MPa
B: At least 30 ml/m²·d·MPa to less than 50 ml/m²·d·MPa
C: At least 50 ml/m²·d·MPa

### Puncture Resistance (Unit: N)

The puncture resistance was measured according to JIS Z-1707. As a measuring device, a Strograph (produced by Toyo Seiki Seisaku-sho, Ltd.) was used.

A: 7N or more
B: 5N or more to less than 7N
C: Less than 5N

### Impact Strength (Unit: J)

The impact strength was measured using an impact tester (produced by Toyo Seiki Seisaku-sho, Ltd.) and a small ball (½ inchφ).

A: 0.5 J or more
B: 0.4 J or more to less than 0.5 J
C: Less than 0.4 J

### Anti-Fogging Properties

A water-containing container was covered with a film having an anti-fogging protective layer inside, and stored in a refrigerator. One hour later, the condition of the film was evaluated.

A: No droplets.
B: Droplets with a diameter of at least 5 mm.
C: Droplets with a diameter of at least 3 mm and less than 5 mm.
D: Droplets with a diameter of less than 3 mm.

### Curling Properties

After storing the film for 24 hours at a temperature and humidity of 23° C.×50% RH atmosphere, the film was set with its curling surface facing upward. The film (10 cm×10 cm (MD×TD)) was diagonally cut on a mat to make a cross-cut incision, and the surface area of mat that could be observed from directly above when the film was curled was measured. The surface area of mat was measured using NIH Image (National Institute of Health) image analysis software, by scanning a picture taken with a digital camera into a personal computer.

A: Less than 10 cm²
B: At least 10 cm² to less than 40 cm²
C: At least 40 cm²

### Stretchability

A flat multilayered film was obtained by coextruding a resin of each layer, so that a layer structure shown in Table 1 could be obtained, through a T die on a chill roll in which cooling water circulated. The multilayered film was stretched to 3 times its original size in the machine direction using a roll stretching machine set at 60° C. Then, the multilayered film was stretched to 4 times its original size in the transverse direction at an atmospheric temperature of 100° C. using a tenter stretching machine, and heat-treated at an atmospheric temperature of 120° C. using the tenter stretching machine. In twenty-four-hour film production under the above conditions, the number of film fractures per 100,000 m was measured.

A: Less than 1 time.
B: 2 times.
C: 3 or more times.

The material resins for the multilayered film used in the Examples and Comparative Examples are as follows.

Resin for polyolefin layer (A):
Linear low-density polyethylene (LLDPE) (2040F (produced by Ube Maruzen Polyethylene Co., Ltd.))
Resin for adhesive layer (B):
Maleic anhydride modified polyolefin resin (NF518 (produced by Mitsui Chemicals, Inc.))
Resin for polyamide layer (C):
Amorphous aromatic polyamide (amorphous nylon): Selar PA 3426 (produced by DuPont-Mitsui Polychemicals Co., Ltd.);
Nylon 6/66 (Ny6/66): (5034B (produced by Ube Industries, Ltd.);
MXDNy: 56007 (produced by Mitsubishi Gas Chemical Co., Inc.); and
Nylon 6 (Ny6): 1022FDX04 (produced by Ube Industries, Ltd.))
Resin for barrier layer (D):
Saponified ethylene vinyl acetate copolymer (EVOH);
Ethylene content: 32 mol % (produced by Nippon Synthetic Chemical Industry Co., Ltd.: DC3203RB)
*1 (Example 7): Saponified ethylene vinyl acetate copolymer (EVOH); Ethylene content: 29 mol % (produced by Nippon Synthetic Chemical Industry Co., Ltd.: DT2904RB)
*2 (Comparative Examples 5 and 6): Saponified ethylene vinyl acetate copolymer (EVOH); Ethylene content: 44 mol % (produced by Nippon Synthetic Chemical Industry Co., Ltd.: AT4403B)
Resin for anti-fogging agent layer (E):
Polyolefin resin: Linear low density polyethylene (LLDPE) (2040F (produced by Ube Maruzen Polyethylene Co., Ltd.));
Anti-fogging agent: Rikemaster EAR-5;
Base resin: Low-density polyethylene, melt index 8, and additive concentration: 12% (Riken Vitamin Co., Ltd.)
Resin for anti-fogging agent volatilization-preventing layer (F):
Polyolefin resin: Linear low-density polyethylene (LLDPE) (2040F (produced by Ube Maruzen Polyethylene, Co., Ltd.))

### Example 1

Linear low-density polyethylene (LLDPE), maleic anhydride modified polyolefin resin, a mixed resin of amorphous aromatic polyamide (amorphous nylon) (5 wt %) and nylon 6 (95 wt %), a saponified ethylene vinyl acetate copolymer (EVOH) (ethylene content: 32 mol %), a mixture in which 15 wt % of an anti-fogging agent was added to a linear low-density polyethylene (LLDPE), and linear low-density polyethylene (LLDPE) were used as a resin for a polyolefin layer (A), a resin for an adhesive layer (B), a resin for a polyamide layer (C), a resin for a barrier layer (D), a resin composition for an anti-fogging agent layer (E), and a resin for an anti-fogging agent volatilization-preventing layer (F), respectively.

A flat eight-layer film was prepared by coextruding a resin of each layer in A/B/C/D/C/B/E/F (layer structure I) order through a T die on a chill roll in which cooling water circulated. The eight-layer film was stretched to 3 times its original size in the machine direction using a roll stretching machine set at 60° C., and stretched to 4 times its original size in the transverse direction at an atmospheric temperature of 100° C. using a tenter stretching machine. Further, the multilayered film was heat-treated at an atmospheric temperature of 120° C. using the tenter stretching machine. The eight-layer film having a thickness of 25 μm was thus obtained. The thickness of each layer was shown in Table 1.

### Examples 2 to 7

As shown in Table 1, the multilayered film was produced in the same manner as in Example 1, except that the content of amorphous aromatic polyamide in the polyamide layer (C), and optionally, the thickness of each layer, was changed. In Example 7, the multilayered film was produced in the same manner as in Example 1, except that a saponified ethylene vinyl acetate copolymer (EVOH) (ethylene content: 29 mol %) was used as a barrier layer (D).

### Examples 8 to 10

As shown in Table 1, the multilayered film was obtained in the same manner as in Example 1, except that the layer structure was changed to II (A/B/D/C/D/B/E/F), III (A/B/C/D/B/E/F), or IV (A/B/D/C/B/E/F). The multilayered film was produced in the same manner as in Example 1, except that the thickness of each layer was changed.

### Comparative Example 1

The multilayered film was produced in the same manner as in Example 1, except that nylon 6 (Ny6) was used for the polyamide layer (C).

### Comparative Example 2

The multilayered film was produced in the same manner as in Example 1, except that 90 wt % of Nylon 6 (Ny6) and 10 wt % of Nylon 6/66 (Ny6/66) were used for the polyamide layer (C).

### Comparative Example 3

The multilayered film was produced in the same manner as in Example 1, except that 90 wt % of Nylon 6 (Ny6) and 10 wt % of MXDNy were used for the polyamide layer (C).

### Comparative Example 4

As shown in Table 1, the multilayered film was produced in the same manner as in Example 1, except that the amount of amorphous aromatic polyamide in the polyamide layer (C) was changed.

### Comparative Example 5

In Comparative Example 5, the multilayered film was produced in the same manner as in Example 1, except that 90 wt % of Nylon 6 (Ny6) and 10 wt % of MXDNy were used for the polyamide layer (C), and a saponified ethylene vinyl acetate copolymer (EVOH) (ethylene content of 44 mol %) was used for the barrier layer (D).

### Comparative Example 6

Using the polyamide layer (C) containing amorphous aromatic polyamide in an amount shown in Table 1, the multilayered film was obtained in the same manner as in Example 1, except that a saponified ethylene vinyl acetate copolymer (EVOH) (ethylene content: 44 mol %) was used for the barrier layer (D).

### Comparative Example 7

Using the polyamide layer (C) containing amorphous aromatic polyamide in an amount shown in Table 1, the multilayered film was obtained in the same manner as in Example 1, except that the film had an A/B/C/D/C/B/E layer structure (layer structure V).

### Comparative Example 8

Using 70 wt % of nylon 6 (Ny6) and 30 wt % of MXDNy as the polyamide layer (C), the multilayered film was obtained in the same manner as in Example 1, except that the film had an A/B/C/D/C/B/E layer structure (layer structure V).

### Comparative Example 9

Using Nylon 6/66 (Ny6/66) as a polyamide layer (C), the multilayered film was produced in the same manner as in Example 1, except that the film had an A/B/C/D/C/B/E layer structure (layer structure V). The resulting multilayered film had a layer thickness of 30 μm.

### Comparative Example 10

Using the polyamide layer (C) containing amorphous aromatic polyamide in an amount shown in Table 1, the multilayered film was obtained in the same manner as in Example 1, except that the film had a C/D/C/B/E/F layer structure (layer structure VI).

Table 1 shows the multilayered films obtained in the Examples and Comparative Examples, and the evaluation results thereof. The film in Comparative Example 9 had a total thickness of 30 μm, and other films had a total thickness of 25 μm.

### Layer Structure

Symbols I to VI in the “Layer structure” column shown in Table 1 indicate the following.

### I: A/B/C/D/C/B/E/F

### II: A/B/D/C/D/B/E/F

### III: A/B/C/D/B/E/F

### IV: A/B/D/C/B/E/F

### V: A/B/C/D/C/B/E

### VI: C/D/C/B/E/F

TABLE 1

| | | | | Material (wt %) of polyamide | | | | | | | | | |
|---|---|---|---|---|---|---|---|---|---|---|---|---|---|
| | | | | layer (C) | | | | | | | | | |
| | | | | | Amorphous | | | | | | | | |
| | Layer | Total | | | aromatic | | | Oxygen | | | Anti- | | |
| | struc- | thick- | Layer thickness | | poly- | Ny6/ | | permea- | Puncture | Impact | fogging | | Stretcha- |
| | ture | ness | (μm) | Ny6 | amide | 66 | MXDNy | bility | resistance | strength | properties | Curling | bility |
| Ex. 1 | I | 25 | 3/2/5/2/5/2/5/1 | 95 | 5 | — | — | A 13.8 | A 9.0 | A 0.86 | B | A | A 1 |
| Ex. 2 | I | 25 | 3/2/5/2/5/2/5/1 | 90 | 10 | — | — | A 14.8 | A 8.5 | A 0.79 | B | A | A 0 |
| Ex. 3 | I | 25 | 3/2/5/2/5/2/5/1 | 80 | 20 | — | — | A 13.8 | A 8.1 | A 0.70 | B | A | A 0 |
| Ex. 4 | I | 25 | 3/2/5/2/5/2/5/1 | 70 | 30 | — | — | A 14.8 | A 7.1 | A 0.58 | B | A | A 0 |
| Ex. 5 | I | 25 | 2/2/3/2/3/2/10/1 | 80 | 20 | — | — | A 15.8 | B 6.6 | A 0.52 | A | B | A 1 |
| Ex. 6 | I | 25 | 3/2/4/4/4/2/5/1 | 90 | 10 | — | — | A 7.9 | A 7.9 | A 0.71 | B | A | A 0 |
| Ex. 7 *1 | I | 25 | 3/2/5/2/5/2/5/1 | 90 | 10 | — | — | A 11.8 | A 8.6 | A 0.77 | B | A | A 0 |
| Ex. 8 | II | 25 | 3/2/1/10/1/2/5/1 | 90 | 10 | — | — | A 13.8 | A 8.7 | A 0.79 | B | A | A 0 |
| Ex. 9 | III | 25 | 3/2/10/2/2/5/1 | 90 | 10 | — | — | A 13.8 | A 8.8 | A 0.77 | B | A | A 0 |
| Ex. 10 | IV | 25 | 3/2/2/10/2/5/1 | 90 | 10 | — | — | A 14.8 | A 8.5 | A 0.77 | B | A | A 0 |
| Comp. | I | 25 | 3/2/5/2/5/2/5/1 | 100 | — | — | — | A 13.8 | A 9.5 | A 0.93 | B | A | C 8 |
| Ex. 1 | | | | | | | | | | | | | |
| Comp. | I | 25 | 3/2/5/2/5/2/5/1 | 90 | — | 10 | — | A 13.8 | A 9.2 | A 0.94 | B | A | C 5 |
| Ex. 2 | | | | | | | | | | | | | |
| Comp. | I | 25 | 3/2/5/2/5/2/5/1 | 90 | — | — | 10 | A 14.8 | A 9.0 | A 0.85 | B | A | C 3 |
| Ex. 3 | | | | | | | | | | | | | |
| Comp. | I | 25 | 3/2/5/2/5/2/5/1 | 60 | 40 | — | — | A 15.8 | C 4.8 | C 0.37 | B | A | A 1 |
| Ex. 4 | | | | | | | | | | | | | |
| Comp. | I | 25 | 3/2/5/2/5/2/5/1 | 90 | — | — | 10 | C 106.6 | A 8.9 | A 0.85 | B | A | A 1 |
| Ex. 5 *2 | | | | | | | | | | | | | |
| Comp. | I | 25 | 3/2/5/2/5/2/5/1 | 90 | 10 | — | — | C 106.6 | A 8.5 | A 0.87 | B | A | A 0 |
| Ex. 6 *2 | | | | | | | | | | | | | |
| Comp. | V | 25 | 4/2/5/2/5/2/5 | 90 | 10 | — | — | A 14.8 | A 8.3 | A 0.80 | D | A | A 0 |
| Ex. 7 | | | | | | | | | | | | | |
| Comp. | V | 25 | 3/2/4/2/4/2/8 | 70 | — | — | 30 | A 14.8 | A 7.2 | A 0.51 | D | A | C 3 |
| Ex. 8 | | | | | | | | | | | | | |
| Comp. | V | 30 | 7/2/4/3/4/2/8 | — | — | 100 | — | A 10.9 | A 7.6 | A 0.89 | D | A | C 4 |
| Ex. 9 | | | | | | | | | | | | | |
| Comp. | VI | 25 | 7/3/7/2/5/1 | 90 | 10 | — | — | A 16.8 | A 10.2 | A 0.97 | B | C | A 0 |
| Ex. 10 | | | | | | | | | | | | | |

1. A multilayered film comprising a polyolefin layer (A), an adhesive layer (B), a polyamide layer (C), a barrier layer (D), an anti-fogging agent layer (E), and an anti-fogging agent volatilization-preventing layer (F),
the polyamide layer (C) comprising 5 to 30 wt % of amorphous aromatic polyamide,
the barrier layer (D) comprising a saponified ethylene vinyl acetate copolymer (EVOH) having an ethylene content of 35 mol % or less and a saponification degree of vinyl acetate of 90 mol % or more,
the anti-fogging agent layer (E) comprising an anti-fogging agent and polyolefin, and
the anti-fogging agent volatilization-preventing layer (F) comprising polyolefin; and
the multilayered film having an (A)/(B)/(X)/(B)/(E)/(F) layer structure (wherein the layer (X) represents a (C)/(D)/(C), (D)/(C)/(D), (C)/(D), or (D)/(C) layer structure).

2. The multilayered film according to claim 1, wherein each of the polyolefins contained in the polyolefin layer (A), the anti-fogging agent layer (E), and the anti-fogging agent volatilization-preventing layer (F) is linear low-density polyethylene (LLDPE) and/or low-density polyethylene (LDPE).

3. The multilayered film according to claim 1, wherein the amorphous aromatic polyamide contained in the polyamide layer (C) is at least one member selected from the group consisting of polymers of hexamethylenediamine/isophthalic acid, polymers of hexamethylenediamine/terephthalic acid, and copolymers of hexamethylenediamine/terephthalic acid/hexamethylenediamine/isophthalic acid.

4. The multilayered film according to claim 1, wherein the content of the anti-fogging agent in the anti-fogging agent layer (E) is 15,000 to 40,000 ppm.

5. The multilayered film according to claim 1, wherein the multilayered film is biaxially stretched 2 to 4.5 times its original size in a machine direction, and 2.5 to 5 times its original size in a transverse direction.

6. The multilayered film according to claim 1, wherein the multilayered film has a total thickness of 10 to 50 μm.

7. The multilayered film according to claim 1, wherein the thickness of the anti-fogging agent volatilization-preventing layer (F) is 0.5 to 3 μm.

8. The multilayered film according to claim 1, wherein the total thickness of the polyamide layer (C) is 20 to 60% of the total thickness of the multilayered film.

9. The multilayered film according to claim 1, wherein the thickness of the layer (X) is 3 to 40 μm.

10. The multilayered film according to claim 1, wherein the ratio ((C)/(D)) of the total thickness of the polyamide layer(s) (C) to the total thickness of the barrier layer(s) (D) in the layer (X) is 1/2 to 30/1.

11. The multilayered film according to claim 1, wherein the multilayered film has at least an eight-layer (A)/(B)/(C)/(D)/(C)/(B)/(E)/(F) structure.

12. The multilayered film according to claim 1, wherein the multilayered film is a heat-shrinkable film.

13. A method for producing a multilayered film comprising laminating a resin for a polyolefin layer (A), a resin for an adhesive layer (B), a resin for a polyamide layer (C) comprising to 30 wt % of amorphous aromatic polyamide, a resin for a barrier layer (D) comprising a saponified ethylene vinyl acetate copolymer (EVOH) having an ethylene content of 35 mol % or less, and a saponification degree of vinyl acetate of 90 mol % or more, a resin for an anti-fogging agent layer (E) comprising an anti-fogging agent and polyolefin, and a resin for an anti-fogging agent volatilization-preventing layer (F) comprising polyolefin, by co-extrusion so that the film has a layer structure in (A)/(B)/(X)/(B)/(E)/(F) order (wherein the layer (X) represents a (C)/(D)/(C), (D)/(C)/(D), (C)/(D), or (D)/(C) structure).
